(19) United States
(12) Patent Application Publication
(10) Pub. No.: US 2007/0209257 A1
(43) Pub. Date: Sep. 13, 2007

(54) Apparatus for raising and lowering a banner that maintains the banner tensioned

(76) Inventor: Paul J. Britten, Traverse City, MI (US)

Correspondence Address: HARNESS, DICKEY & PIERCE, P.L.C., P.O. BOX 828, BLOOMFIELD HILLS, MI, 48303, US

(21) Appl. No.: 11/649,320

(22) Filed: Jan. 3, 2007

Related U.S. Application Data
(60) Provisional application No. 60/756,249, filed on Jan. 4, 2006.
(60) Provisional application No. 60/775,863, filed on Feb. 22, 2006.

(51) Int. Cl. G09F 7/00

(52) U.S. Cl. 40/601

(57) ABSTRACT

An apparatus for raising and lowering an article maintains the article tensioned (horizontal and vertical) both when it is in position and also when it is being raised and lowered. In an aspect, the apparatus includes an upper tensioning bar coupled to an upper edge of the article and a lower tensioning bar coupled to a lower edge of the article. The upper and lower tensioning bars are movably mounted on a plurality of vertically extending horizontally spaced apart tracks for vertical movement therealong. One or more tensioners are coupled to an opposed side edge of the article and mounted to one of the tracks for vertical movement therealong. In an aspect, tensioners are coupled to both opposed side edges of the article and mounted to respective ones of the tracks. A raising and lowering device is coupled to the upper tensioning bar, such as by ropes or cables, and raises and lowers upper tensioning bar, thus raising and lowering the display article. The upper and lower tensioning bars keep the article vertically tensioned and the tensioners keep the article horizontally tensioned, both when the article is in position and when it is being raised and lowered. In an aspect, the tracks are mounted on a side of a building.

### CROSS-REFERENCE TO RELATED APPLICATIONS

This application claims the benefit of U.S. Provisional Application No. 60/756,249 filed Jan. 4, 2006 and U.S. Provisional Application No. 60/775,863 filed Feb. 22, 2006. The disclosures of the above applications are incorporated herein by reference.

### FIELD OF THE INVENTION

The present invention relates to display articles, such as banners, that are hung outdoors, such as from sides of buildings, and more particularly, to an apparatus for raising and lowering the display article that keeps the display article horizontally and vertically tensioned.

### BACKGROUND OF THE INVENTION

Banners, posters or other types of display articles are used for textual and/or graphical displays. They are hung in a variety of different places and locations. When location is an outdoor location, it is often necessary to keep the display article tensioned in all directions (i.e., vertically and horizontally) to minimize the possibility of wind damage, including when the article is being raised and lowered.

### SUMMARY OF THE INVENTION

An apparatus for raising and lowering an article in accordance with the invention maintains the article tensioned (horizontal and vertical) both when it is in position and also when it is being raised and lowered. In an aspect, the apparatus includes an upper tensioning bar coupled to an upper edge of the article and a lower tensioning bar coupled to a lower edge of the article. The upper and lower tensioning bars are movably mounted on a plurality of vertically extending horizontally spaced apart tracks for vertical movement therealong. One or more tensioners are coupled to an opposed side edge of the article and mounted to one of the tracks for vertical movement therealong. In an aspect, tensioners are coupled to both opposed side edges of the article and mounted to respective ones of the tracks. A raising and lowering device is coupled to the upper tensioning bar, such as by ropes or cables, and raises and lowers upper tensioning bar, thus raising and lowering the display article. The upper and lower tensioning bars keep the article vertically tensioned and the tensioners keep the article horizontally tensioned, both when the article is in position and when it is being raised and lowered. In an aspect, the tracks are mounted on a side of a building.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side plan view of an apparatus for raising and lowering a display article and maintaining it tensioned horizontally and vertically in accordance with an aspect of the invention;

FIG. 2 is a section of the apparatus of FIG. 1 taken along the line 2-2 of FIG. 1;

FIG. 3 is a variation of the apparatus of FIG. 1;

FIG. 4 is a section of the apparatus of FIG. 3 taken along the line 4-4 of FIG. 3; and

FIG. 5 is a variation of the apparatuses of FIGS. 1 and 3.

### DETAILED DESCRIPTION OF THE PREFERRED EMBODIMENTS

The following description of the preferred embodiment(s) is merely exemplary in nature and is in no way intended to limit the invention, its application, or uses. It should be understood that throughout the drawings, corresponding reference numerals indicate like or corresponding parts and features.

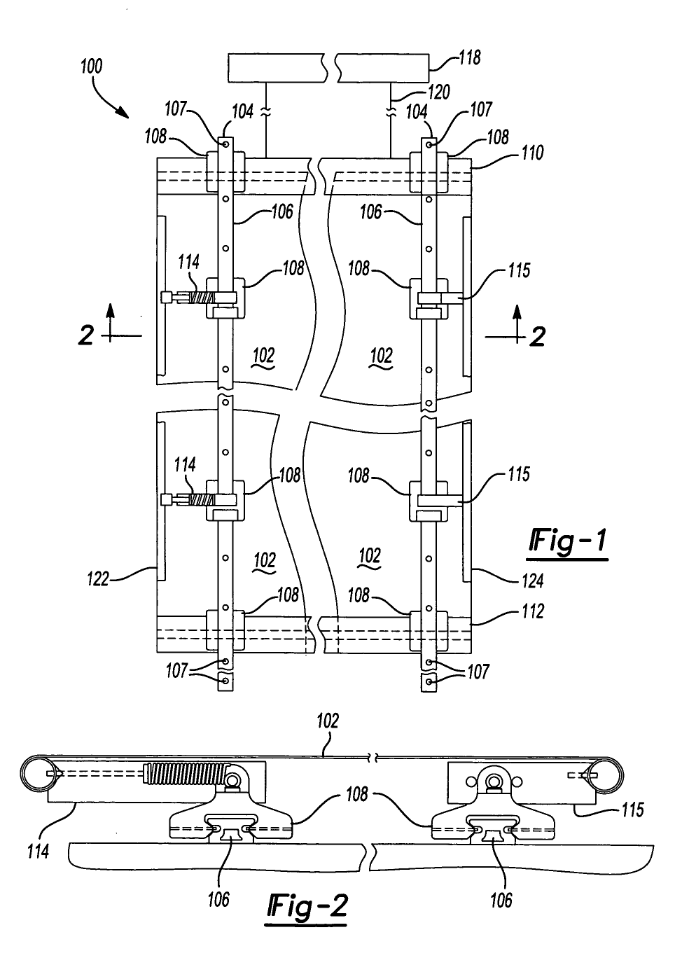

Referring to FIGS. 1 and 2, an apparatus 100 for raising and lowering a display article 102 is shown. Display article 102 can be any type of article that is hung for display, such as banners. Apparatus 100 includes a linear rail system 104 that has a plurality of spaced apart vertically extending tracks, such as rail tracks 106. Rail tracks 106 include mounting holes 107 to facilitate mounting tracks 106 on a vertical surface, such as a side of a building, such as with bolts (not shown). A plurality of rail trolleys or trucks 108 are movably mounted on tracks 106 for reciprocal movement therealong. An upper tensioning bar 110 is mounted to upper rail trucks 108 and a lower tensioning bar 112 is mounted to a lower rail trucks 108. Upper tensioning bar 110 is attached to an upper end of display article 102 and lower tension bar 112 is attached to a lower end of display article 102. Tensioners 114 are mounted to one or more (illustratively all) of the intermediate rail trucks 108 that are mounted on one of the tracks 106. Attachment brackets 115 are mounted to one or more (illustratively all) of the intermediate rail trucks that are mounted on the other track 106. In an aspect, tensioners 114 may be mounted to the intermediate rail trucks 108 that are mounted on both of tracks 106 and attachment brackets 115 dispensed with. The intermediate rail trucks 108 are the rail trucks 108 that are disposed between the upper pair of rail trucks 108 to which the upper tensioning bar is mounted and the lower pair of rail trucks 108 to which the lower tensioning bar is mounted. Tensioners 114 are affixed to a vertically extending side edge 122 of display article 102 and attachment brackets 115 are affixed to an opposite vertically extending side edge 124 of display article 102. Tensioners 114 and attachment brackets 115, in the embodiment of FIGS. 1 and 2, project outwardly from tracks 106. Tensioners 114 are any type of device that, in the embodiment shown in FIG. 1, urge side edge 122 of display article 102 outwardly. They may, for example, include a shaft (not shown) reciprocally mounted to rail truck 108 and attached at a distal end to side edge 122 of display article 102. The shaft may illustratively be surrounded by a compression spring (not shown) that urges the shaft outwardly to apply horizontal tension to display article 102.

A raising and lowering device 118 is coupled to upper tensioning bar 110, such as by ropes, cables or chains 120. Raising and lowering device 118 can be any type of device that raises and lowers upper tensioning bar 110. For example, raising and lowering device 118 may be a winch type of device that winds and unwinds ropes, cables or chains 120. Tracks 106 are mounted to extend vertically, such as to a side of a building. Tracks 106 are mounted such that when the display article 102 is lowered, it is in an accessible location permitting its removal and the attachment of a new display article 102 to apparatus 100, or to repair display article 102.

In an aspect, rail trucks 108 are coupled to each other only through display article 102. As such, the weight of lower tensioning bar 112 applies vertical tension to display article 102. In another aspect, rail trucks 108 are loosely coupled to each other, such as by cables, to keep them together to some extent when a display article 102 is not affixed to apparatus 100. In another aspect, tension devices, such as compression springs, are disposed between rail trucks 108 to apply vertical tension to display article 102.

Apparatus 100 maintains both vertical and horizontal tension in display article 102, both when display article 102 is stationary and when apparatus 100 is raising and lowering display article 102.

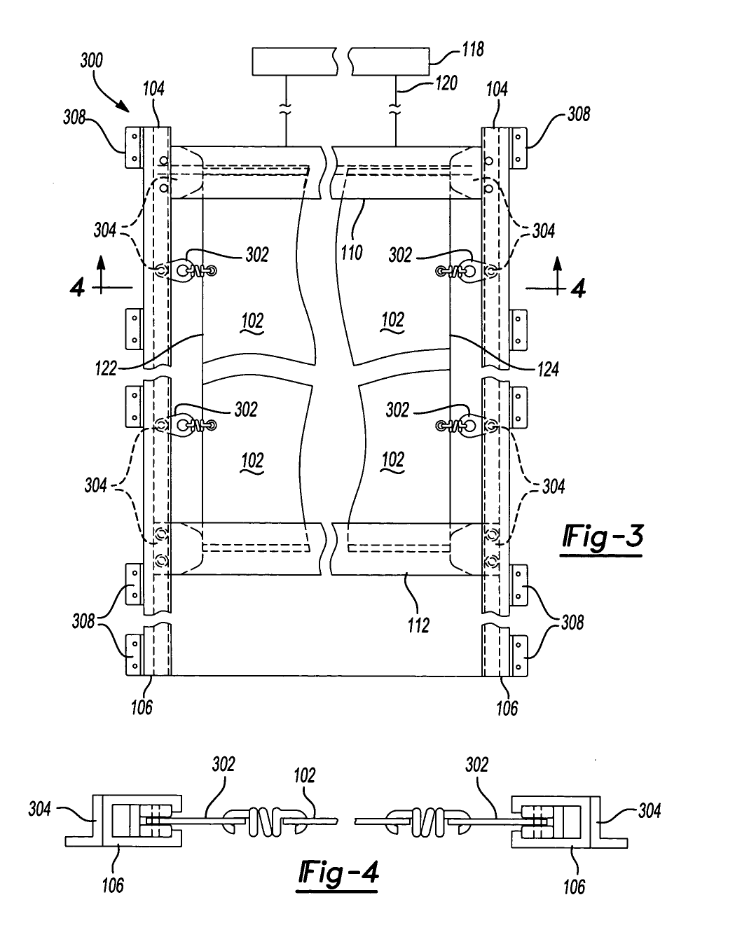

FIGS. 3 and 4 show an apparatus 300 for raising and lowering a display article 102 that is a variation of apparatus 100 of FIG. 1. Like elements will be identified with like reference numbers, with the discussion focusing on the differences. In apparatus 100, display article 102 is wider than the space between tracks 106 so that side edges 122, 124 of display article 102 extend outwardly from tracks 106 and horizontal tension is applied to the side edges 122, 124 of display article 102 outwardly from tracks 106. In apparatus 300, display article 102 is narrower than the space between tracks 106 and horizontal tension is applied to side edges 122, 124 of display article 102 between tracks 106.

Upper tensioning bar 110, lower tensioning bar 112 and tensioners 302 are mounted on rail trolleys 304 that in turn are movably mounted on tracks 106 for vertical movement therealong. Tensioners 302 project inwardly from tracks 106 and are attached to opposed side edges 122, 124 of display article 102. Tensioners 302 may include tension springs that pull side edges 122, 124 of display article 124 outwardly. Apparatus 300 thus maintains display article 102 tensioned both vertically and horizontally in much the same way as apparatus 100. Tracks 106 include mounting brackets 308 to facilitate mounting tracks 106 on a vertical surface, such as a side of a building.

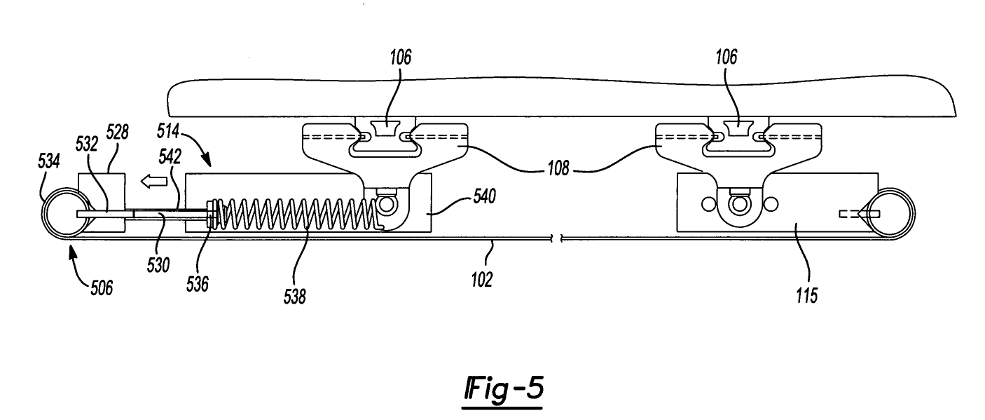

FIG. 5 shows a variation of the above described apparatuses 100, 300. More specifically, FIG. 5 is a top view of a tensioner 514 and an attachment bracket 115 mounted on rail trolleys or trucks 504 that in turn are mounted on tracks 106. Tensioner 514 is affixed to an edge of display article 102 (such as a banner) by a fixing member 526. Fixing member 526 may illustratively include a movable block 528 in which an end 532 of shaft 530 is received and an eyelet 534 that is affixed to the display article 102, to movable block 528 and end 532 of shaft 530. An opposite end 536 of shaft 530 is coupled to an end of spring 538. An opposite end of spring 538 is coupled to rail trolley or truck 108 as is fixed block 540. Shaft 530 may illustratively be disposed in a cylinder 542 that extends between the end of spring 538 to which shaft end 536 is attached and movable block 528.

In the illustrative embodiment shown in FIG. 5, spring 538 is a compression spring and pushes movable block 528 away from fixed block 540 to apply horizontal tension to display article 102.

What is claimed is:

1. An apparatus for raising and lowering a display article, comprising:
a plurality of spaced apart vertical tracks;
a plurality of trucks movably mounted on the tracks including an upper truck mounted on each track, a lower truck mounted on each track and at least one intermediate truck mounted on each track;
an upper tensioning bar mounted to the upper trucks and a lower tensioning bar mounted to the lower trucks, the upper tensioning bar attached to an upper end of the display article and the lower tensioning bar attached to a lower end of the display article, the upper and lower tensioning bars cooperating to apply vertical tension to the display article;
a tensioner attached to at least one of the intermediate trucks on one of the tracks and to a side edge of the article, the tensioner applying horizontal tension to the display article; and
a raising and lowering device coupled to the upper tensioning bar that raises and lowers the display article.

2. The apparatus of claim of claim 1 including a second tensioner or an attachment bracket attached to at least one of the intermediate trucks mounted on the other track, the second tensioner or attachment bracket attached to a side edge of the display article opposite the side edge to which the first tensioner is attached.

3. The apparatus of claim 1 including a tensioner attached to each intermediate truck mounted on the one track, each tensioner attached to one side of the display article, and an attachment bracket attached to each intermediate truck mounted on the other track, each attachment track attached to a side of the displayer article opposite the side of the display article to which each tensioner is attached.

4. The apparatus of claim 3 including a plurality of intermediate trucks mounted on each track.

5. The apparatus of claim 1 including a tensioner attached to each intermediate truck, each tensioner attached to each truck mounted on one track attached to one side of the display article and each tensioner attached to each truck mounted on the other track attached to an opposite side of the display article.

6. The apparatus of claim 5 including a plurality of intermediate trucks mounted on each track.

7. The apparatus of claim 3 wherein the display article is wider than a distance between the tracks so that the tracks are disposed between opposite sides of the display article and each tensioner pushes the display article outwardly from the truck to which that tensioner is attached.

8. The apparatus of claim 5 wherein the display article is wider than a distance between the tracks so that the tracks are disposed between opposite sides of the display article and each tensioner pushes the display article outwardly from the truck to which that tensioner is attached.

9. The apparatus of claim 3 wherein the display article is narrower than a distance between the tracks so that the display article is disposed between the tracks and each tensioner pulls the display article inwardly toward the truck to which that tensioner is attached.

10. The apparatus of claim 5 wherein the display article is narrower than a distance between the tracks so that the display article is disposed between the tracks and each tensioner pulls the display article inwardly toward the truck to which that tensioner is attached.

11. The apparatus of claim 1 wherein the display article is a banner.

12. The apparatus of claim 7 wherein the display article is a banner.

13. The apparatus of claim 8 wherein the display article is a banner.

14. The apparatus of claim 9 wherein the display article is a banner.

15. The apparatus of claim 10 wherein the display article is a banner.
